(19) United States
(12) Patent Application Publication
(10) Pub. No.: US 2014/0029093 A1
(43) Pub. Date: Jan. 30, 2014

(54) STEREO DISPLAY PANEL, APPARATUS FOR STEREO DISPLAY, AND METHOD FOR STEREO DISPLAYING

(71) Applicants: Jong Oh Lee, Siheung-si (KR); Gyo Hyun Lee, Siheung-si (KR)

(72) Inventors: Jong Oh Lee, Siheung-si (KR); Gyo Hyun Lee, Siheung-si (KR)

(21) Appl. No.: 14/111,502

(22) PCT Filed: Apr. 9, 2012
(86) PCT No.: PCT/KR2012/002680

§ 371 Date: Oct. 11, 2013

(30) Foreign Application Priority Data
Apr. 11, 2011 (KR) 10-2011-0033507
Jun. 8, 2011 (KR) 10-2011-0055039

(51) Int. Cl. G02B 27/22

(52) U.S. Cl. CPC G02B 27/2214
USPC 359/462

(57) ABSTRACT

A stereo display panel, according to the present embodiment, has a plurality of unit pixels which are defined and enables an n perspective, wherein the n is an integral that is greater than or equal to 2 and is a multiple of integral p and integral q, wherein a q number of unit pixels that are adjacent in a row direction form one unit row, and a p number of the unit rows are adjacent in a column direction so as to enable the n perspective. When the n is the sum of integral z and integral y, an image for enabling the n perspective comprises the z number of input images and the y number of compensation images.

### TECHNICAL FIELD

The present invention relates to a stereo display panel, an apparatus for stereo display, and a method for stereo displaying.

### BACKGROUND ART

Three-dimensional image display technology is a technology that allows a user to feel a cubic effect by the binocular parallax in which a difference occurs between images of the left eye and the right eye. A method of viewing a three-dimensional image can be classified into a glass mode and a glassless mode. The glass mode has an inconvenience in that a user needs to wear glasses, and it may be difficult for a user to observe objects except stereo images while wearing glasses. Accordingly, studies for glassless mode are being extensively conducted.

The glassless mode may be classified into a lenticular method using a cylindrical lens and a parallax barrier method using a light transmitting part and a light blocking part. In the lenticular method, since a lens is used, a distortion of an image may occur. On the other hand, the parallax barrier method has an advantage in that stereo viewing is possible from different positions.

However, when a stereo image of a multi-view is implemented using a parallax barrier method, a ratio of a light transmitting part is very low. That is, when n number of views are implemented, a ratio of a light transmitting part to a light blocking part becomes 1:(n−1) and thus a ratio of the light transmitting part inevitably becomes very low. Thus, when the ratio of the light transmitting part is lowered, a ratio of a portion of a display device where an image is displayed is reduced, and thus the resolution may be deteriorated.

Meanwhile, when the number of views increases, the time taken to manufacture the contents for a multi-view may be elongated, and a boundary between views may be felt by a user.

### DISCLOSURE

### Technical Problem

The present invention provides a stereo display panel, an apparatus for stereo display, and a method for stereo displaying, which can improve the screen quality and reduce the time necessary for manufacturing contents while implementing a multi-view.

### Technical Solution

In accordance with an aspect of the present invention, there is provided a stereo display panel defining a plurality of unit pixels and implementing n views, wherein: n is an integer greater than or equal to 2 and a product of an integer p and an integer q; q unit pixels adjacent to each other in a row direction forms one unit row; p unit rows adjacent to each other in a column direction implements the n views; and an image implementing the n views comprises z input images and y compensation images when the integer n is a sum of an integer z and integer y.

The integer z may be expressed as Equation (1)

z=(n/2)+1 (1)

The z input images may include a first image, a second image, . . . , z-th image, and the y compensation images may include a second image, . . . , (z−1)th image.

The integer n may be a multiple of 2 and the integer p is 2. The q unit pixels adjacent to each other in the row direction may form a first unit row. The q unit pixels adjacent to the first unit row in the column direction and adjacent to each other in the row direction may form a second unit row. Also, the first unit row and the second unit row may implement the n views.

In the display panel, a unit pixel image corresponding to an odd number among images of the n views may be projected to the first unit row, and a unit pixel image corresponding to an even number among the images of the n views may be projected to the second unit row.

In the display panel, n unit pixels implementing the n views may be upwardly shifted one by one to a right side by one unit pixel.

In the display panel, unit pixel images corresponding to odd numbers may be projected to a lower row of the first and second unit rows, and unit pixel images corresponding to even numbers may be projected to an upper row of the first and second unit rows.

In the display panel, n unit pixels implementing the n views may be upwardly shifted one by one to a left side by one unit pixel.

In the display panel, unit pixel images corresponding to even numbers may be projected to a lower row of the first and second unit rows, and unit pixel images corresponding to odd numbers may be projected to an upper row of the first and second unit rows.

In accordance with another aspect of the present invention, there is provided a stereo display panel defining a plurality of unit pixels and implementing n views, wherein when n is a sum of an integer z and an integer y, an image implementing the n views comprises z input images and y compensation images, and the integer z may be expressed as Equation (1)

z=(n/2)+1 (1).

In accordance with another aspect of the present invention, there is provided a stereo display apparatus comprising: a stereo display panel according to any one of claims 1 to 10; and a parallax barrier positioned at one surface of the stereo display panel.

The parallax barrier may include a plurality of light transmitting part and a plurality of light blocking part that correspond to the plurality of unit pixels, respectively, and when assuming that a value obtained by subtracting 1 from q is m, one unit pixel corresponding to the light transmitting part and m unit pixels corresponding to the light blocking part in a row direction may be repeatedly disposed.

The light transmitting part may be formed along a diagonal direction of the display panel, and when assuming that a width of a unit pixel in a row direction is A and a length of a unit pixel in a column direction is B, a slope C of the light transmitting part may be expressed as Equation (2)

0.95*{(p*B)/A}≦C≦1.05*{(p*B/A)} (2)

In accordance with another aspect of the present invention, there is provided a stereo displaying method in a display panel defining a plurality of unit pixels and implementing n views, wherein: n is an integer greater than or equal to 2 and a product of an integer p and an integer q; q unit pixels adjacent to each other in a row direction forms one unit row; p unit rows adjacent to each other in a column direction implements the n views; and an image implementing the n views comprises z input images and y compensation images when the integer n is a sum of an integer z and integer y.

The integer z may be expressed as Equation (1).

z=(n/2)+1 (1).

The z input images may include a first image, a second image, z-th image, and the y compensation images may include a second image, (z−1)th image.

The integer n may be a multiple of 2 and the integer p may be 2. The q unit pixels adjacent to each other in the row direction may form a first unit row. The q unit pixels adjacent to the first unit row in the column direction and adjacent to each other in the row direction may form a second unit row. Also, the first unit row and the second unit row may implement the n views.

In the display panel, a unit pixel image corresponding to an odd number among images of the n views may be projected to the first unit row, and a unit pixel image corresponding to an even number among the images of the n views may be projected to the second unit row.

### Advantageous Effects

In a stereo display apparatus according to an exemplary embodiment of the present invention, even when implementing a multi-view of the same n number, the stereo display apparatus is driven to increase a light transmitting part ratio in the parallax barrier and thus luminance and a resolution can be improved. In this case, in order to implement n views, when using the n number of unit pixels, by enabling n to be a multiple of 2 and by disposing the n number of unit pixels at two rows, a horizontal line can be prevented from occurring in an image implemented in a display panel. Accordingly, the image quality and luminance can be improved.

Also, in this embodiment, since only z input images are extracted using z input images and y compensation images to implement n views, the time taken to manufacture contents can be reduced. Furthermore, since the y compensation images include the second image to the (z−1)th image, a user may not feel the boundary between views and images may be recognized as smooth.

### BRIEF DESCRIPTION OF DRAWINGS

FIG. 1 is a cross-sectional view illustrating a three-dimensional display apparatus according to an embodiment of the present invention.

FIG. 2 is a cross-sectional view illustrating a three-dimensional display apparatus according to a modified embodiment of the present invention.

FIG. 3 is a flowchart illustrating a three-dimensional display method using a three-dimensional display apparatus according to an embodiment of the present invention.

FIG. 4 is a view illustrating a parallax according to an image in a three-dimensional display method according to an embodiment of the present invention.

FIG. 5 is a view illustrating a parallax according to an image in a typical three-dimensional display method.

FIG. 6 is a plan view illustrating unit pixels of a display panel and a light blocking part and a light transmitting part of a parallax barrier corresponding thereto according to an embodiment of the present invention.

FIG. 7 is a plan view illustrating unit pixels implementing a multi-view in a display panel and a light blocking part and a light transmitting part of a parallax barrier corresponding thereto according to an embodiment of the present invention.

FIG. 8 is a view illustrating an image distribution in a display panel according to an embodiment of the present invention.

FIG. 9 is a view illustrating an image distribution in a display panel according to another embodiment of the present invention.

FIG. 10 is a plan view illustrating unit pixels implementing a multi-view in a typical display panel and a light blocking part and a light transmitting part of a typical parallax barrier corresponding thereto.

FIG. 11 is a plan view illustrating unit pixels implementing a multi-view in a display panel and a light blocking part and a light transmitting part of a parallax barrier corresponding thereto according to another embodiment of the present invention.

FIG. 12 is a cross-sectional view illustrating a three-dimensional display apparatus according to another embodiment of the present invention.

### BEST MODES FOR CARRYING OUT THE INVENTION

Hereinafter, a three-dimensional display apparatus and a three-dimensional display method according to an embodiment of the present invention will be described in detail with reference to the accompanying drawings.

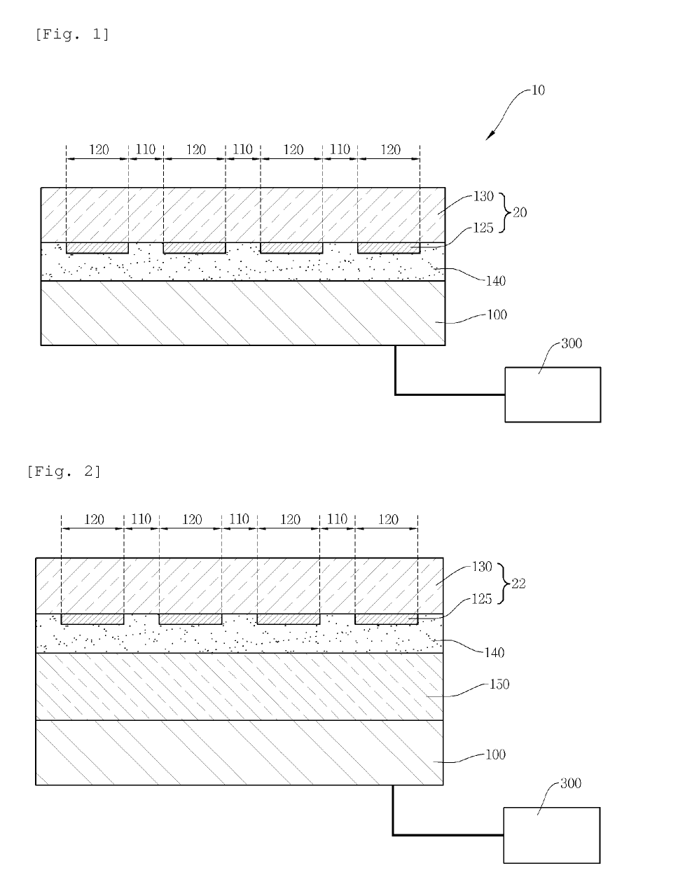

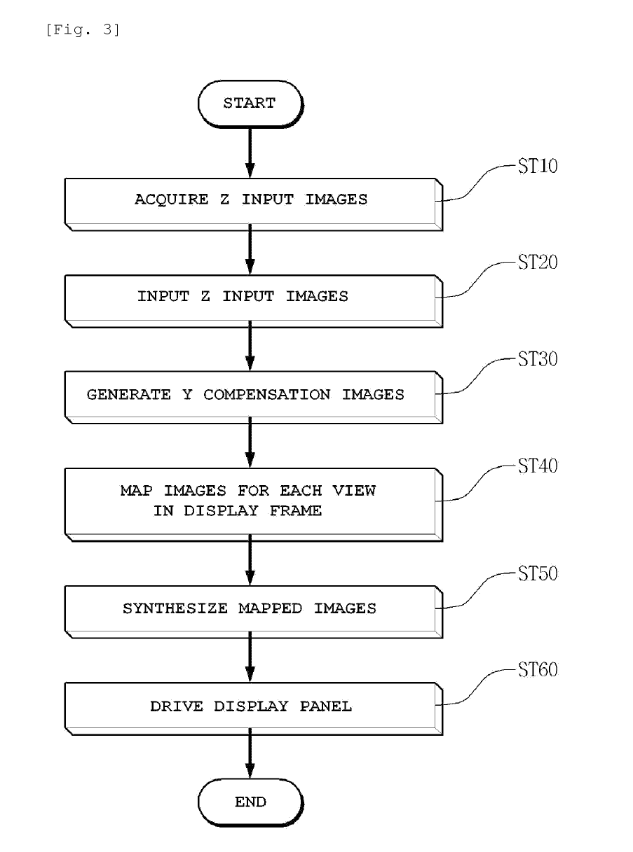

FIG. 1 is a cross-sectional view illustrating a three-dimensional display apparatus according to an embodiment of the present invention. FIG. 2 is a cross-sectional view illustrating a three-dimensional display apparatus according to a modified embodiment of the present invention.

Referring to FIG. 1, a three-dimensional display apparatus 10 according to an embodiment of the present invention may include a display panel 100 defining a plurality of unit pixels (hereinafter, see 210 of FIG. 3) and implementing a multi-view, a driving part 300 for controlling the driving of the display panel 100, and a parallax barrier 20 disposed on one surface (more specifically, front surface) of the display panel 100.

For example, the display panel 100 may include a Liquid Crystal Display (LCD), a Plasma Display Panel (PDP), and a display panel using a Light Emitting Diode (LED). However, the present invention is not limited thereto, and various types of display panels 100 may be used.

In the display panel 100, a plurality of unit pixels 210 may be defined in row and column directions. In this embodiment, a multi-view image may be implemented in the display panel 100. Hereinafter, the number of views of the display panel 100 will be assumed to be n for convenience of explanation. Here, n may be an integer greater than or equal to 2.

The driving part 300 may control the driving of the display panel 100, and may provide a multi-view image signal to the display panel 100 to implement a three-dimensional image by the multi-view.

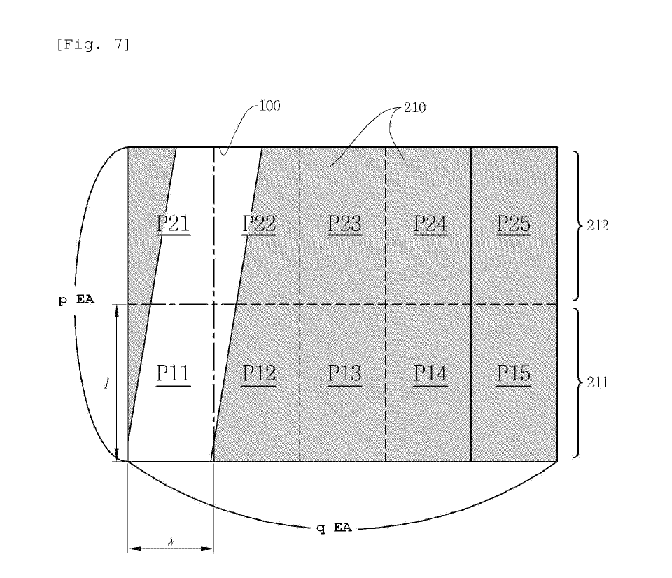

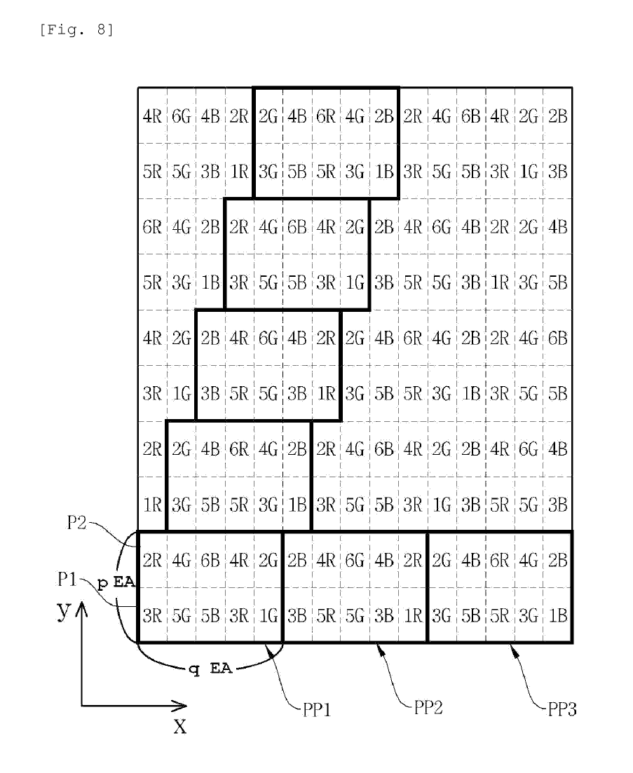

In this embodiment, the driving part 300 may allow a multi-view image to be implemented by the unit pixels 210 defined in multiple rows and columns. A detailed description thereof will be made later with reference to FIGS. 6 and 7. For reference, in a related art, a multi-view image is displayed in multiple columns of a single row.

The parallax barrier 20 disposed on the front surface of the display panel 100 may selectively transmit the multi-view image to form a parallax barrier such that an observer can see different images with both eyes. For this, the parallax barrier 20 may include a plurality of light transmitting parts 110 and a plurality of light blocking part 120 corresponding to the unit pixels 210 of the display panel 100, respectively.

More specifically, as shown in FIG. 1, the parallax barrier 20 may include a transparent substrate 130 and a barrier pattern 125 formed on the transparent substrate 130.

Here, the barrier pattern 125 may be formed by coating and drying an ultraviolet ink or a thermosetting ink and then performing a patterning process, but the present invention is not limited thereto. A portion where the barrier pattern 125 is formed may define the light blocking part 120, and the other portion where the barrier pattern 125 is not formed may define the light transmitting part 110. A two-dimensional layout of the light blocking part 120 and the light transmitting part 110 will be described in detail with reference to FIGS. 6 and 7.

The transparent substrate 130 may be a glass substrate. When a glass substrate is used as the transparent substrate 130, the transmittance may be high, allowing a separate substrate to be omitted. Accordingly, an image implemented on the display panel 100 may be allowed to be transmitted with a high transmittance without a limitation such as a distortion.

On the other hand, a typical parallax barrier is used by laminating patterned polymer films (e.g., polyethylene phthalate and polyethylene terephthalate (PET) films) on a tempered glass using an adhesive. Generally, the transmittance of the polymer film and the tempered glass is lower than the transmittance of typical glass, and thus a typical parallax barrier using the polymer film and the tempered glass inevitably has a significantly low transmittance. Also, a destructive interference may occur due to refractive indexes of polymer film, tempered glass and adhesive, and thus a moiré phenomenon may occur.

Thus, in this embodiment, since the transparent substrate 130 may be formed of a glass substrate, a high transmittance can be achieved without an image distortion. However, the present invention is not limited to the material of the transparent substrate 130, and various kinds of materials can be used for the transparent substrate 130.

The parallax barrier 20 may be fixedly attached to the front surface of the display panel 100 via an adhesive layer 140. The adhesive layer 140 may be formed of various materials, for example, an ultraviolet adhesive, a visible light adhesive, an infrared adhesive and a heat adhesive.

It is preferable that such a bonding layer 140 has a refractive index similar to that of the transparent substrate 130, and thus minimizes moiré and prevents Newton ring from occurring. For example, when the transparent substrate 130 is formed with a glass substrate, the bonding layer 140 may have a refractive index of about 1.48-1.54 similar to that of a glass substrate.

FIG. 1 illustrates that the parallax barrier 20 is formed with the transparent substrate 130 and the barrier pattern 125 formed on the transparent substrate 130. However, the present invention is not limited thereto.

Therefore, in a modified example, as shown in FIG. 2, a parallax barrier 22 may include a transparent substrate 130, a barrier pattern 125, a bonding layer 140 formed on the transparent substrate 130 and the barrier pattern 125, and a separate transparent substrate 150 bonded by the bonding layer 140. The above-described separate transparent substrate 150 may include the same material as that of the transparent substrate 130. In the present modified example, the parallax barrier 22 and the display panel 100 may be coupled by a bonding layer (not shown) or a fixed member (not shown). In addition, a parallax barrier having various sectional structures may be used.

A two-dimensional structure of the above-described parallax barrier 20 and a three-dimensional display method in the display panel 100 in which the parallax barrier 20 is used will be described in detail with reference to FIGS. 3 to 9.

FIG. 3 is a flowchart illustrating a three-dimensional display method using a three-dimensional display apparatus according to an embodiment of the present invention.

Referring to FIG. 3, the three-dimensional display method may include acquiring z input images (ST10), inputting the z input images (ST20), generating y compensation images (ST30), mapping images for each view in a display frame (ST40), synthesizing the mapped images (ST50), and driving a display panel (ST60). Here, z and y are integers, and the sum of z and y is n.

Thus, in this embodiment, in order to implement n views, n input image are not used, but z input images and y compensation images are used, which will be described in more detail.

First, in the acquiring of the z input images (ST10), z (z is smaller than n) input images may be extracted. In this embodiment, since only z (smaller than n) input images are extracted while implementing n views, the time taken to extract the input images can be reduced.

Next, in the inputting of the z input images (ST20), the z input images extracted may be inputted, and in the generating of the y compensation image (ST30), the y compensation images may be generated from the z input images.

For example, n may be a multiple of 2. The reason why n is a multiple of 2 will be described later. In this case, z may be expressed as Equation (1).

z=(n/2)+1 (1)

For example, when n is 10 (i.e., 10 views are implemented), z may become 6, and y may become 4. In this case, the first to sixth images may be inputted as the input images, and the second to fifth images may be generated as the compensation images. That is, the y compensation images may be images from the second image to (z−1)th image.

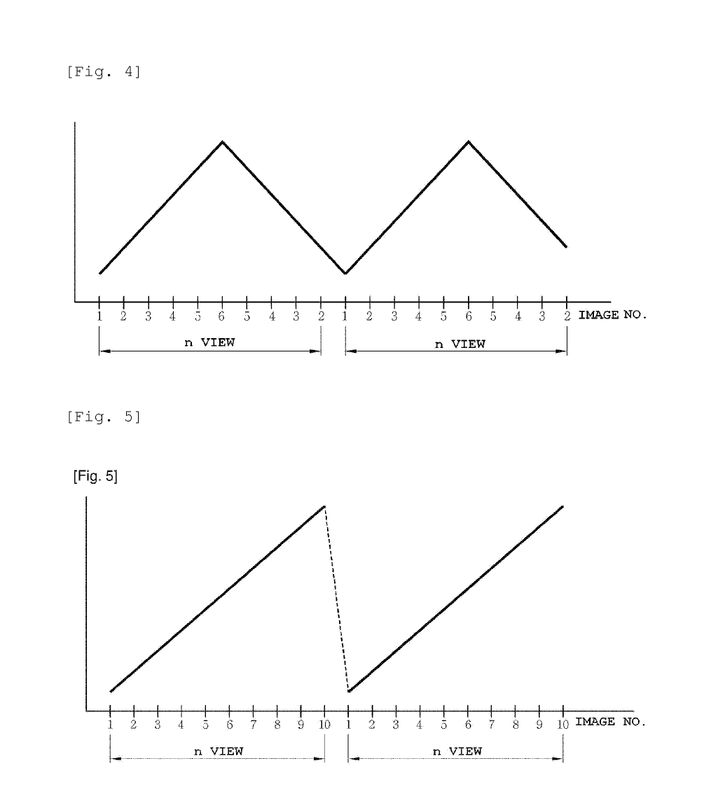

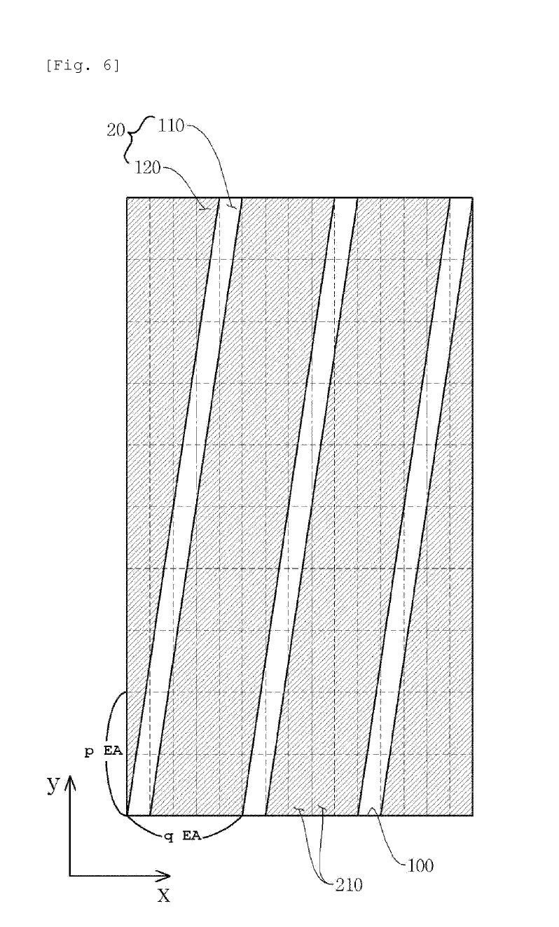

Then, when an image of n views is implemented, the boundary of view can be reduced, providing a smooth image. A detailed description thereof will be made with reference to FIGS. 4 and 5.

FIG. 4 is a view illustrating a parallax according to an image in a three-dimensional display method according to an embodiment of the present invention. FIG. 5 is a view illustrating a parallax according to an image in a typical three-dimensional display method.

As an example, although n is illustrated as 10, the present invention is not limited thereto. Accordingly, n may vary, and particularly, n may be a multiple of 2. For clearer description in the drawing, images (e.g., first and second images) adjacent to each other are shown as having the same parallax.

Referring to FIG. 4, in this embodiment, the first, second, third, fourth, fifth, sixth, fifth, fourth, third, and second images may be projected by the parallax barrier (see 20 of FIG. 1) to be visible, and then the first, second, third, fourth, fifth, sixth, fifth, fourth, third, and second images may be projected to be visible. On the whole, since the first, second, third, fourth, fifth, sixth, fifth, fourth, third, second, first, second, third, fourth, fifth, fourth, third, and second images are sequentially projected, a portion where the parallax is significant may not occur. Accordingly, a user may not feel the boundary between views, and the images may be recognized as smooth.

On the other hand, referring to FIG. 5, in a related art, the first, second, third, fourth, fifth, sixth, seventh, eighth, ninth, and tenth images are sequentially projected, and then the first, second, third, fourth, fifth, sixth, seventh, eighth, ninth, and tenth images are sequentially projected. On the whole, since the first, second, third, fourth, fifth, sixth, seventh, eighth, ninth, tenth, first, second, third, fourth, fifth, sixth, seventh, eighth, ninth, and tenth images are sequentially projected, a user feels a significant parallax at the boundary of the tenth image and the first image. Accordingly, a user feels inconvenience due to the boundary of views.

That is, in this embodiment, a user may not feel the boundary between views and images may be recognized as smooth, using the z input images and the y compensation images.

Referring again to FIG. 3, in the mapping of the images for each view in the display frame (ST40), the image for each view may be mapped in a predetermined location of the display frame, and in the synthesizing of the mapped images (ST50), the mapped images may be synthesized to acquire a desired image. Next, in the driving of the display panel (ST60), a signal corresponding to the synthesized image may be provided to the display panel 100 to drive the display panel 100.

FIG. 6 is a plan view illustrating unit pixels of a display panel and a light blocking part and a light transmitting part of a parallax barrier corresponding thereto according to an embodiment of the present invention.

FIG. 7 is a plan view illustrating unit pixels implementing a multi-view in a display panel and a light blocking part and a light transmitting part of a parallax barrier corresponding thereto according to an embodiment of the present invention.

Referring to the drawings, in the present exemplary embodiment, in the display panel 100, a plurality of unit pixels 210 are defined. More specifically, a plurality of unit pixels 210 are disposed while having a plurality of columns in a row direction (x-axis direction of the drawing) and having a plurality of rows in a column direction (y-axis direction of the drawing). Such unit pixels 210 include red color pixels that emit red color light, green color pixels that emit green color light, and blue color pixels that emit blue color light. For example, one red color pixel, one green color pixel, and one blue color pixel adjacent in a row direction may display an image by forming one pixel, but the present invention is not limited thereto. Therefore, by including a color other than a red color, a green color, and a blue color, the unit pixel 210 forms one pixel and may be variously deformed.

In the display panel 100 of the present exemplary embodiment, when displaying an image having the view number of the n number, n views are not implemented in unit pixels 120 of one row or one column and are displayed in unit pixels 120 of a plurality of rows and a plurality of columns. However, the present invention is not limited thereto.

More specifically, unit pixels of the q number adjacent in a row direction form one unit row. N views are implemented by the unit pixels 210, i.e., unit pixels of the p number*the q number shown in FIG. 7 positioned at unit rows of the p number adjacent in a column direction. Here, n is an integer of 2 or more, p and q are integers that are divisors of n, and the product of p and q becomes n. More accurately, n views are implemented using the unit pixels 210 positioned by a plurality of columns and a plurality of rows, and at least two rows and two columns should be provided and thus n is an integer of 4 or more.

For example, in FIGS. 6 and 7, the 10 view number are implemented using two of a unit row formed with adjacent five unit pixels in a row direction. That is, when using two of a unit row formed with adjacent 5 unit pixels in a row direction, total 10 unit pixels are formed and thus 10 views are implemented. Here, q becomes five, and p becomes 2. In the drawings, for example, the 10 view number is illustrated, but the present invention is not limited thereto. Therefore, the present invention may have various values of n, p, and q.

Here, as described above, n may be a multiple of 2, and p may be 2. Therefore, n views may be implemented with a first unit row (hereinafter, “odd number row”) 211 including unit pixels of the q number adjacent in a row direction and a second unit row (hereinafter, “even number row”) 212 adjacent to the odd number row and including unit pixels of the q number adjacent in a row direction. Thereby, by diffraction of light, a phenomenon in which a horizontal line occurs in an image implemented in the display panel 100 can be prevented.

More specifically, when n is the odd number, p and q are also the odd number, and in this case, due to diffraction of light, a horizontal line may occur in an image implemented in the display panel 100. When n is a multiple of 3, such a phenomenon may more remarkably occur.

For example, when 9 views are implemented with unit pixels of 3 columns and 3 rows, a horizontal line may occur. In consideration of this, in the present invention, by forming n in a multiple of 2 and forming p in 2, a horizontal line is minimized from occurring. Further, it is preferable that all of n, p, and q are not a multiple of 3.

In this case, the driver (reference numeral 300 of FIG. 1), a unit pixel image corresponding to the odd number among n views is positioned at the first unit row 211, and a unit pixel image corresponding to the even number among n views is positioned at the second unit row 212. That is, in a case of 10 views, for example, a first image is projected to a fifteenth unit pixel P15 of the first unit row 211, a third image is projected to a fourteenth unit pixel P14, a fifth image is projected to a thirteenth unit pixel p13, a fifth image is projected to a twelfth image p12, a third image is projected to an eleventh unit pixel P11, a second image is projected to a twenty-fifth unit pixel P25 of the second unit row 212, a fourth image is projected to a twenty-fourth unit pixel P24, a sixth image is projected to a twenty-third unit pixel P23, a fourth image is projected to a twenty-second unit pixel P22, and a second image is projected to a twenty-first unit pixel P21. More specifically, an image projected from the entire display panel 100 will be described as follows.

FIG. 8 is a view illustrating an image distribution in a display panel according to an embodiment of the present invention. Referring to FIG. 8, 10 unit pixels PP for implementing n views may have an oblique form shifted to the right by one unit pixel while advancing upward. In this case, in first and second unit rows constituting 10 unit pixels PP, in a unit row P1 positioned at a lower portion, first, third, fifth, fifth, and third images are positioned from the right to the left, and in a unit row P2 positioned at an upper portion, second, fourth, sixth, fourth and second images are positioned from the right to the left.

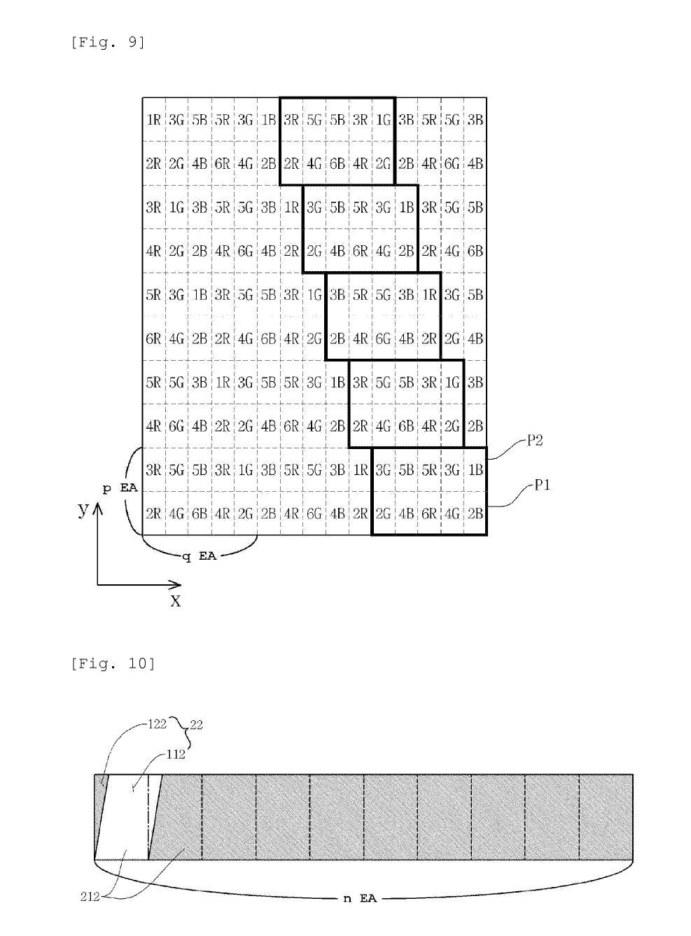

However, the present invention is not limited thereto, and as shown in FIG. 9, 10 unit pixels PP for implementing n views may have an oblique form shifted to the left by one unit pixel while advancing upward. In this case, in a unit row P1 positioned at a lower portion of the first and second unit rows constituting 10 unit pixels PP, the second, fourth, sixth, fourth and second images are positioned from the right to the left, and in a unit row P2 positioned at an upper portion, first, third, fifth, fifth and third images are positioned from the right to the left.

Also, when representing red, green and blue, red, green and blue may be alternately positioned in a row direction of the unit rows constituting the 10 unit pixels PP. Thus, red, green, and blue images of the images for each view may all be provided in three of 10 unit pixels PP adjacent to each other.

For example, the third image (red) may be positioned at the 11 pixel (hereinafter, see P11 of FIG. 7) of the unit pixels PP1 positioned at the leftmost side of the drawing. The third image (blue) may be positioned at the 11 pixel P11 of the unit pixels PP2 positioned at the center of the drawing. The third image (green) may be positioned at the 11 pixel P11 of the unit pixels PP3 positioned at the rightmost side of the drawing. The fifth image (green) may be positioned at the 12 pixel (hereinafter, see P12 of FIG. 7) of the unit pixels PP1 positioned at the leftmost side of the drawing. The fifth image (red) may be positioned at the 12 pixel P12 of the unit pixels PP2 positioned at the center of the drawing. The fifth image (blue) may be positioned at the 12 pixel P12 of the unit pixels PP3 positioned at the rightmost side of the drawing. The fifth image (blue) may be positioned at the 13 pixel (hereinafter, see P13 of FIG. 7) of the unit pixels PP1 positioned at the leftmost side of the drawing. The fifth image (green) may be positioned at the 13 pixel P13 of the unit pixels PP2 positioned at the center of the drawing. The fifth image (red) may be positioned at the 13 pixel P13 of the unit pixels PP3 positioned at the rightmost side of the drawing. For example, the third image (red) may be positioned at the 14 pixel (hereinafter, see P14 of FIG. 7) of the unit pixels PP1 positioned at the leftmost side of the drawing. The third image (blue) may be positioned at the 14 pixel P14 of the unit pixels PP2 positioned at the center of the drawing. The third image (green) may be positioned at the 14 pixel P14 of the unit pixels PP3 positioned at the rightmost side of the drawing.

The first image (green) may be positioned at the 15 pixel (hereinafter, see P15 of FIG. 7) of the unit pixels PP1 positioned at the leftmost side of the drawing. The first image (red) may be positioned at the 15 pixel P15 of the unit pixels PP2 positioned at the center of the drawing. The first image (blue) may be positioned at the 15 pixel P15 of the unit pixels PP3 positioned at the rightmost side of the drawing. Then, red, green and blue may also be sequentially positioned at each unit row of the unit pixels PP, and red, green, and blue images of the images for each view may all be provided in three of unit pixels PP adjacent to each other. Since applied similarly to the second and fourth images, a detailed description thereof will be omitted herein.

Thus, when 6 input images and 4 compensation images are used for implementing 10 views, as described above, the time taken to manufacture contents can be reduced, and the boundary between views can be removed, thereby achieving a smooth image.

In the parallax barrier 20 used for such a display panel 100, when viewing in a row direction, one unit pixel corresponding to the light transmitting part 110 and unit pixels of the m number corresponding to the light blocking part 120 are repeatedly disposed. Here, m is the number that subtracts 1 from q. In this way, when n views are implemented with columns of the q number and rows of the p number, a ratio of the light transmitting part 110 to the light blocking part 120 is 1:m (i.e., 1:(q−1)) and thus a ratio of the light blocking part 120 may be decreased and a ratio of the light transmitting part 110 may be increased. In this way, by increasing a ratio of the light transmitting part 110, there is a merit that luminance and a resolution may be increased.

For more clear description, this will be described with reference to FIGS. 7 and 10. FIG. 10 is a plan view illustrating unit pixels implementing a multi-view in a typical display panel and a light blocking part and a light transmitting part of a typical parallax barrier corresponding thereto.

In the present exemplary embodiment, as shown in FIG. 7, when n is 10, p is 2, and q is 5, when viewing in a row direction from the parallax barrier 20, a ratio of the light transmitting part 110 to the light blocking part 120 is 1:4. That is, when implementing 10 views, in the parallax barrier 20, a ratio of the light transmitting part 110 to the light blocking part 120 is 1:4.

However, as shown in FIG. 10, typically, in order to implement n views, images of the n number are displayed in adjacent unit pixels 212 of the n number in one row, and when viewing in a row direction from a parallax barrier 22, a ratio of a light transmitting part 112 to a light blocking part 122 is 1:(n−1). For example, when implementing 10 views, in the parallax barrier 22, a ratio of the light transmitting part 112 to the light blocking part 122 is 1:9.

Therefore, in the present exemplary embodiment, even while implementing a multi-view of the same number, a ratio of the light transmitting part 110 in the parallax barrier 20 can be enhanced and thus luminance and a resolution can be increased to correspond thereto. For example, as described above, when n is a multiple of 2 and p is 2, luminance and a resolution can be increased by the double or more.

In the drawing, for briefly describing, it is illustrated that the light transmitting part 110 and a unit pixel 210 have the same size, but the present invention is not limited thereto. Actually, a size of the light transmitting part 110 corresponding to each unit pixel 210 may be smaller than that of each unit pixel 210.

When the number of views is large rather than when the number of views is small, a size ratio of the light transmitting part 110 may be relatively enlarged. This is designed so that a wavelength of light passes to one unit pixel 210 with the constant number of times, and thus an interference phenomenon is minimized, and therefore a moiré phenomenon is minimized. In consideration of a process error together with this, a width ratio of the light transmitting part 110 to the light blocking part 120 may be 0.95:(m+0.05) to 1.33:(m−1.33). More preferably, a width ratio of the light transmitting part 110 to the light blocking part 120 may be 0.95:(m+0.05) to 1.2:(m−1.2).

In the present exemplary embodiment, as the light transmitting part 110 is formed in a diagonal direction of the display panel 100, a multi-view image can be softly expressed. In this case, as described above, the parallax barrier 20 of the present exemplary embodiment excellently enables a transmittance and a refractive index characteristic and thus a moiré phenomenon can be effectively prevented from occurring.

In this case, as described above, when a multi-view is implemented in unit pixels positioned at rows of the p number and columns of the q number, a slope of the light transmitting part 110 is larger than that of the typical light transmitting part 112. That is, when a width w of a unit pixel according to a row direction is A and a length l of a unit pixel according to a column direction is B, a slope C of the light transmitting part 110 is theoretically expressed by Equation (2).

C=(p*B)/A (2)

Actually, when it is considered that an error may exist, a slope C of the light transmitting part 110 is expressed by Equation (3).

0.95*{(p*B)/A}≦C≦1.05*{(p*B/A)} (3)

In consideration of a length l and a width w of a commercialized unit pixel, a slope of the light transmitting part 110 may be about 79° to about 82°.

However, as shown in FIG. 10, in a related art in which unit pixels for implementing n views are positioned at one row, a slope of the light transmitting part 112 is a value obtained by dividing B by A. Therefore, a slope of the light transmitting part 112 of the related art is much smaller than that of the light transmitting part 110 of the present exemplary embodiment. In this way, in the present exemplary embodiment, by enabling a slope of the light transmitting part 110 to be larger than that of the related art, a ratio of the light transmitting part 110 may be relatively increased.

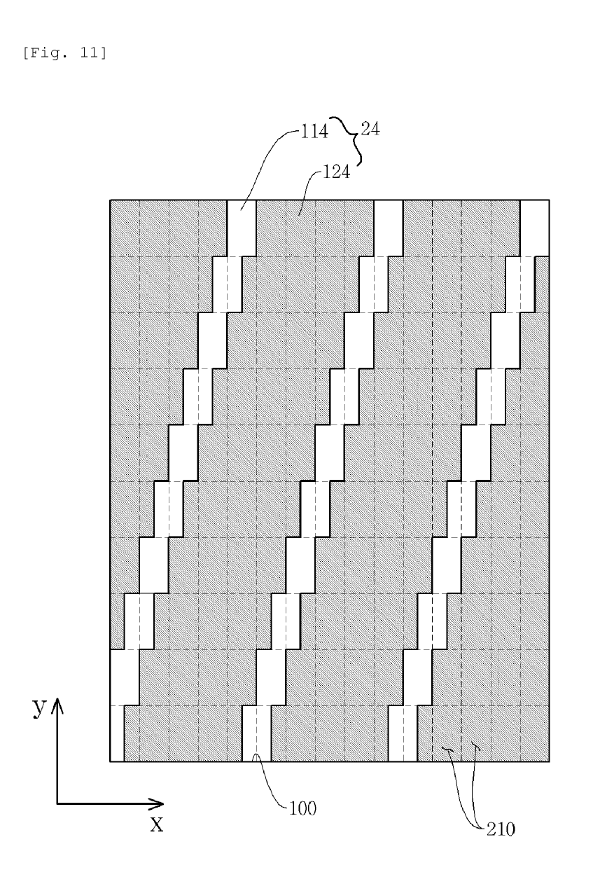

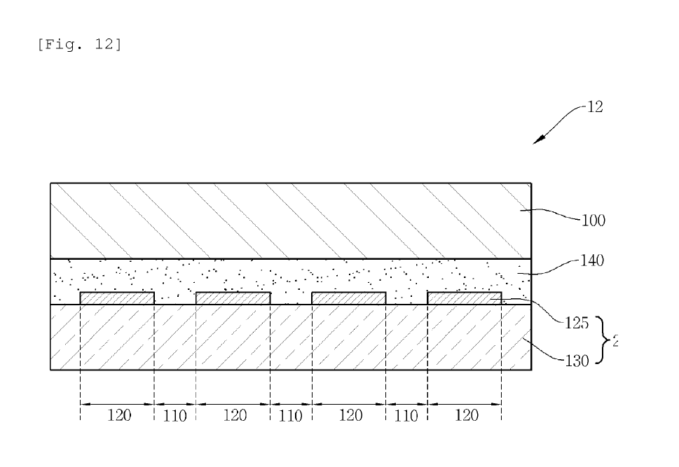

In the above-described description and drawings, it was illustrated that a boundary line of the light transmitting part 110 has an oblique form. However, the present invention is not limited thereto and as shown in FIG. 11, in a parallax barrier 24, at least a portion of a boundary line of a light blocking part 124 and a light transmitting part 114 may be formed in a diagonal direction of the display panel 100 while having a stair shape following a boundary of the unit pixels 210. In more detail, in one row, a boundary line of the light transmitting part 114 substantially corresponds with a boundary line of the unit pixels 210, and in another row adjacent thereto, a boundary line of the light transmitting part 114 substantially corresponds with a virtual center line of the unit pixels 210. A boundary of a multi-view image is cleared by the light transmitting part 114 having such a shape and thus a clear image can be implemented.

The present invention is not limited thereto and a light transmitting part of various shapes may be formed.

Further, in a passive light emitting stereo display apparatus 12 using a backlight unit (not shown), a parallax barrier 20 may be positioned at a rear surface of a display panel 100, as shown in FIG. 12. In this case, a width of a light transmitting part 110 of the parallax barrier 20 may be formed larger than that of a unit pixel. Thereby, because a barrier line may not be seen to a user, the user's negative feeling that may occur by the barrier line may be removed.

The above-described characteristics, structures, and effects are included in at least an exemplary embodiment of the present invention and are not limited only to one exemplary embodiment. Furthermore, characteristics, structures, and effects illustrated in each exemplary embodiment may be combined or deformed, and performed in other exemplary embodiments by a person of ordinary skill in the art to which exemplary embodiments belong. Therefore, it should be analyzed that contents related to such a combination and deformation are included in the scope of the present invention.

1. A stereo display panel defining a plurality of unit pixels and implementing n views, wherein:
n is an integer greater than or equal to 2 and a product of an integer p and an integer q;
q unit pixels adjacent to each other in a row direction forms one unit row;
p unit rows adjacent to each other in a column direction implements the n views; and
an image implementing the n views comprises z input images and y compensation images when the integer n is a sum of an integer z and integer y.

2. The stereo display panel of claim 1, wherein the integer z is expressed as Equation (1)
z=(n/2)+1 (1)

3. The stereo display panel of claim 1, wherein the z input images comprise a first image, a second image, . . . , z-th image, and the y compensation images comprise a second image, . . . , (z−1)th image.

4. The stereo display panel of claim 3, wherein:
the integer n is a multiple of 2 and the integer p is 2;
the q unit pixels adjacent to each other in the row direction form a first unit row;
the q unit pixels adjacent to the first unit row in the column direction and adjacent to each other in the row direction form a second unit row; and
the first unit row and the second unit row implement the n views.

5. The stereo display panel of claim 4, wherein in the display panel, a unit pixel image corresponding to an odd number among images of the n views is projected to the first unit row, and a unit pixel image corresponding to an even number among the images of the n views is projected to the second unit row.

6. The stereo display panel of claim 4, wherein in the display panel, n unit pixels implementing the n views are upwardly shifted one by one to a right side by one unit pixel.

7. The stereo display panel of claim 6, wherein in the display panel, unit pixel images corresponding to odd numbers are projected to a lower row of the first and second unit rows, and unit pixel images corresponding to even numbers are projected to an upper row of the first and second unit rows.

8. The stereo display panel of claim 4, wherein in the display panel, n unit pixels implementing the n views are upwardly shifted one by one to a left side by one unit pixel.

9. The stereo display panel of claim 8, wherein in the display panel, unit pixel images corresponding to even numbers are projected to a lower row of the first and second unit rows, and unit pixel images corresponding to odd numbers are projected to an upper row of the first and second unit rows.

10. A stereo display panel defining a plurality of unit pixels and implementing n views, wherein when n is a sum of an integer z and an integer y, an image implementing the n views comprises z input images and y compensation images, and the integer z is expressed as Equation (1)
z=(n/2)+1 (1).

11. A stereo display apparatus comprising:
a stereo display panel according to claim 1; and
a parallax barrier positioned at one surface of the stereo display panel.

12. The stereo display apparatus of claim 11, wherein the parallax barrier comprises a plurality of light transmitting part and a plurality of light blocking part that correspond to the plurality of unit pixels, respectively, and when assuming that a value obtained by subtracting 1 from q is m, one unit pixel corresponding to the light transmitting part and m unit pixels corresponding to the light blocking part in a row direction are repeatedly disposed.

13. The stereo display apparatus of claim 11, wherein the light transmitting part is formed along a diagonal direction of the display panel, and when assuming that a width of a unit pixel in a row direction is A and a length of a unit pixel in a column direction is B, a slope C of the light transmitting part is expressed as Equation (2)
0.95*{(p*B)/A}≦C≦1.05*{(p*B/A)} (2)

14. A stereo displaying method in a display panel defining a plurality of unit pixels and implementing n views, wherein:
n is an integer greater than or equal to 2 and a product of an integer p and an integer q;
q unit pixels adjacent to each other in a row direction forms one unit row;
p unit rows adjacent to each other in a column direction implements the n views; and
an image implementing the n views comprises z input images and y compensation images when the integer n is a sum of an integer z and integer y.

15. The stereo displaying method of claim 14, wherein the z input images comprise a first image, a second image, . . . , z-th image, and the y compensation images comprise a second image, . . . , (z−1)th image.

16. The stereo displaying method of claim 15, wherein:
the integer n is a multiple of 2 and the integer p is 2;
the q unit pixels adjacent to each other in the row direction form a first unit row;
the q unit pixels adjacent to the first unit row in the column direction and adjacent to each other in the row direction form a second unit row; and
the first unit row and the second unit row implement the n views.

17. The stereo displaying method of claim 16, wherein in the display panel, a unit pixel image corresponding to an odd number among images of the n views is projected to the first unit row, and a unit pixel image corresponding to an even number among the images of the n views is projected to the second unit row.

18. A stereo display apparatus comprising:
a stereo display panel according to claim 2; and
a parallax barrier positioned at one surface of the stereo display panel.

19. A stereo display apparatus comprising:
a stereo display panel according to claim 3; and
a parallax barrier positioned at one surface of the stereo display panel.

20. A stereo display apparatus comprising:
a stereo display panel according to claim 4; and
a parallax barrier positioned at one surface of the stereo display panel.
